(19) United States
(12) Patent Application Publication
(10) Pub. No.: US 2021/0060743 A1
(43) Pub. Date: Mar. 4, 2021

(54) TORQUE WRENCH WITH TORQUE VALUE INDICATION

(71) Applicant: Bobby Hu, Taichung City (TW)

(72) Inventor: Bobby Hu, Taichung City (TW)

(21) Appl. No.: 16/994,718

(22) Filed: Aug. 17, 2020

(30) Foreign Application Priority Data
Aug. 30, 2019 (TW) 108131272

(51) Int. Cl. B25B 23/142

(52) U.S. Cl. CPC B25B 23/1427

(57) ABSTRACT

A torque wrench with torque value indication includes a main body comprising an operation portion for driving a driven member to rotate about an axial center; a torque shaft passing through the main body and having one end connected with the operation portion and another end provided with a drive end exposed from the main body, the torque shaft being bent to deviate from the axis when a torque is generated; and a window disposed on the main body along the axis. The torque shaft gradually bends form the first end toward the second end in accordance with an increase of the torque, so as to correspondingly display a corresponding torque value with different length positions of the torque shaft along the window.

### BACKGROUND OF THE INVENTION

### 1. Field of the Invention

The present invention relates to torque wrenches, and more particularly, to a torque wrench with torque value indication.

### 2. Description of the Related Art

Referring to Taiwan patent M457611, a torque wrench is disclosed, which is applied for fastening or loosening a driven member. With one end of the handle portion disposed on the driving shaft to form a T shape, by wrenching the handle portion to rotate the driving shaft, the sleeve accordingly drives the screw member to rotate, while an indicator pointing a scale on the mark portion for indicating the value. Thus, the torque value imposed by the sleeve on the driven member is acquired. However, for clearly displaying the scale of the mark portion, the mark portion requires a certain transverse width, which is space consuming and unfavorable for the portability of the torque wrench.

Referring to another Taiwan patent M572290, a simple type portable torque wrench tool is disclosed, comprising a wrench body, a sleeve tube, a combination block, an indicator, and a cover. A gauge on the handle is provided with a torque value scale. When the handle is wrenched, the gauge is moved, so that the indicator indicates the torque value of the imposed force. However, the scale of the torque value on the gauge is disposed along the width direction of the wrench body. For facilitating the portability of the device, the gauge has to be as narrow as possible for lowering the space consumption, and the interval between the scales has to be shortened as well. As a result, the scale might be too small to be clearly identified.

Therefore, it is desirable to resolve the issue of clearly indication of the torque value of the torque wrench.

### SUMMARY OF THE INVENTION

For improving the issues above, a torque wrench with torque value indication is disclosed. When the torque shaft is wrenched and driving the target object to a strength and generates a torque, with the bendable property of the torque shaft, a certain length of the torque shaft is disposed in the window, such that the torque value of the target object is acquired.

For achieving the aforementioned objectives, a torque wrench with torque value indication is provided, comprising: a main body having an operation portion on one end thereof, the operation portion driving a target object to rotate about an axial center, two sides of the main body along a width direction being sealed, the main body having a display face; a torque shaft passing through the main body and disposed along an axis, one end of the torque shaft connected with the operation portion, with another end of the torque shaft having a drive end disposed away from the operation portion and exposed from the main body, the drive end being driven toward a direction for wrenching the torque shaft, the torque shaft bending toward a driving direction to deviate from the axis when a torque is generated; and a window formed in an elongate shape and disposed on the display face on the main body along a direction of the axis, the window having a first end and a second end, the torque shaft gradually bending form the first end toward the second end in accordance with an increase of the torque, so as to correspondingly display a torque value of the torque with different length of the torque shaft.

With such configuration, the window is disposed on the main body along the direction of the axis, and the torque value is displayed by the torque shaft bending in the window with different length of the torque shaft in accordance with the increase of the torque. Therefore, compared with the conventional torque wrench whose torque value is displayed along the width direction of the main body, the present invention has a relatively longer travel under an identical size condition, so as to enlarge the display of the torque value, allowing the torque value on the target object to be clearly presented.

### BRIEF DESCRIPTION OF THE DRAWINGS

FIG. 1 is a perspective view of the torque wrench in accordance with the first embodiment of the present invention.

FIG. 2 is a plane view of the torque wrench in accordance with the first embodiment of the present invention.

FIG. 3 is a schematic view illustrating the operation of the torque wrench in accordance with the first embodiment of the present invention.

FIG. 4 is a plane view of the torque wrench in accordance with the second embodiment of the present invention.

FIG. 5 is a plane view of the torque wrench in accordance with the third embodiment of the present invention.

FIG. 6 is a perspective view of the torque wrench in accordance with the fourth embodiment of the present invention.

FIG. 7 is a cross-sectional view taken along line 7-7 of FIG. 6.

FIG. 8 is a plane view of the torque wrench in accordance with the fifth embodiment of the present invention, illustrating the indicator disposed on the torque shaft, and the colored surface layer comprises a border line formed of color difference between the first color zone and the second color zone.

FIG. 9 is a perspective view of the torque wrench in accordance with the fifth embodiment of the present invention.

FIG. 10 is a schematic view illustrating the operation of the torque wrench in accordance with the fifth embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

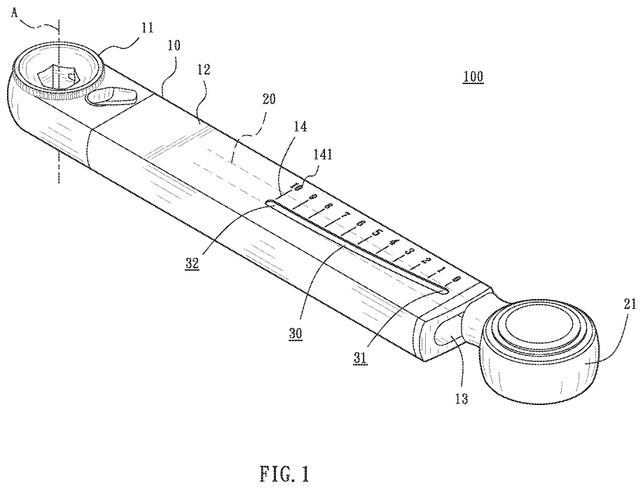

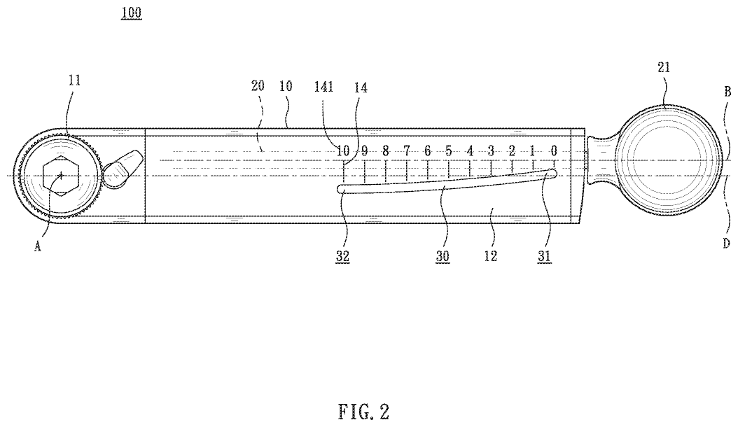

Referring to FIG. 1 to FIG. 10, a torque wrench 100 with torque value indication is provided. In the embodiment, a portable torque value applied for maintenance of bicycles is taken as an example. In the first embodiment, the torque wrench 100 comprises a main body 10, a torque shaft 20, and a torque indication portion, which is a window 30 in the embodiment.

The main body 10 comprises an operation portion 11 on one end thereof. The operation portion 11 is driven to rotate about an axial center A. Two sides of the main body 10 are sealed along the width direction thereof. The main body 10 further comprises a display face 12. In the embodiment, the main body 10 is approximately formed in a cuboid and comprises a length, a width, and a thickness, wherein the ratio between the length and the width is about 7.5:1. The main body 10 is hollow, with an opening 13 disposed on one end away from the operation portion 11 (as shown by FIG. 1).

The operation portion 11 is a driver formed in a ratchet in the embodiment.

The torque shaft 20 passes through the main body 10 and is arranged along an axis B which extends along the length direction of the main body 10. One end of the torque shaft 20 is connected with the operation portion 11, and the other end thereof is provided with a drive end 21 disposed away from the operation portion 11 and exposed from the main body 10 through the opening 13 (as shown by FIG. 1). The drive end 21 is able to be imposed a force toward a driving direction C, such that the torque shaft 20 is wrenched, whereby when a torque is generated, the torque shaft 20 is bent toward the driving direction C. Therein, the driving direction C is the clockwise direction of the main body 10 rotating about the axial center A. Therefore, the torque shaft 20 accordingly deviates from the axis B. The torque shaft 20 is bent to deviate from the axis B, so that the distance from the torque shaft 20 to the axis B gradually increases from the end of the torque shaft 20 connected with the operation portion 11 toward the drive end 21.

The window 30 is formed in an elongate shape and disposed on the main body 10 along the direction of the axis B. The window 30 comprises a first end 31 and a second end 32. When the torque value increases, the torque shaft 20 is bent from the first end 31 toward the second end 32, and the torque value is displayed through the window 30 with different length portions of the torque shaft 20. Also, when the torque shaft 20 is bent, the torque shaft 20 gradually fills the window 30, wherein at least two torque values are filled by the torque shaft 20. In the embodiment, the main body 10 comprises a central line D, which extends along the length direction of the main body 10 and perpendicularly passes through the axial center A. The axis B of the torque shaft 20, which passes through the main body 10, deviates from the central line D with respect to the main body 10 and is disposed in parallel to the central line D. The window 30 is disposed on a route on the main body 10 passing the central line D. In the embodiment, the window 30 is disposed on one display face 12 of the main body 10. However, in different embodiments, the window 30 is allowed to be symmetrically disposed on the display face 12 on two opposite sides of the main body 10, so that the torque value is seen through the window 30 from the display faces 12 on to opposite sides of the main body 10.

In the embodiment, the window 30 is formed in a single opening. In other words, the window 30 is a continuous elongate bore between the first end 31 and the second end 32. Also, the window 30 in the embodiment is formed in an arc shape, wherein the first end 31 is close to the drive end and the axis B, and the second end 32 is away from the drive end 21 and the axis B. In addition, the main body 10 comprises a plurality of scales 14, which are arranged at intervals along the window 30. Each scale 14 is provided with a value 141. When the torque shaft 20 is bent, different scales 141 are indicated for displaying corresponding torque values.

Therein, the values 141 increases from the first end 31 toward the second end 32. In the embodiment, the values 141 are displayed with numbers 0 to 10, whose unit is selected from Kg·m, Nm, and lb·ft. In different embodiments, the first end 31 and the second 32 of the window 30 is allowed to be arranged in opposite, wherein the first end 31 is away from the drive end 21 and the axis B, the second end 32 is close to the drive end 21 and the axis B, and the values 141 increases from the second end 32 toward the first end 31, with the torque shaft 20 bending for indicating the values 141. In a preferred embodiment, the surface of the torque shaft 20 is dyed to display a color which obviously differs from the color of the main body 10, such that the display of the window 30 is clearer and more visible.

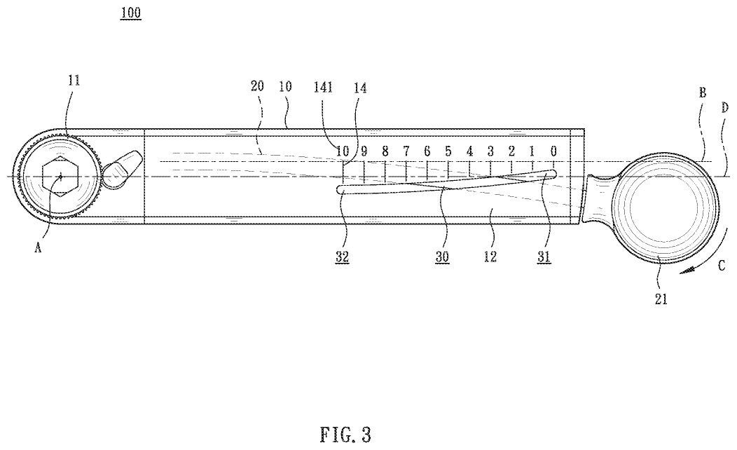

During the actual application of the torque wrench 100, the operation portion 11 is applied for combining a sleeve, and subsequently combining a driven member such as a bolt or nut (not shown). If the fastening direction of the driven member is defined as the driving direction C, the user can manually grips the drive end 21 and wrench the drive end 21 toward the driving direction C. When the driven member initially rotates without generating a torque, the torque shaft 20 is not bent to appear in the window 30, indicating that the torque is 0. When the torque is generated and increases, the torque shaft 20 begins to bend, and a length position thereof which is close to the drive end 21 appears in the window 30, and the scale 14 indicated represents a smaller value 141. With the increasingly bending torque shaft 20, the length position of the torque shaft 20 appearing in the window 30 becomes closer to the operation portion 11, and the indicated values 141 of the scales 14 increase. It is emphasized that, in the present invention, the torque shaft 20 bends to gradually fill the window 30, such that values 141 (torque value) of at least two scales 14 in the window 30 are filled by the torque shaft 20. As shown by FIG. 3, a lateral side of the torque shaft 20 indicates number 7 on the value 141 of the scale 14, and the filled torque values include numbers 3 to 7 on the values 141 of the scale 14. If the torque shaft 20 is further bent toward the driving direction C, the lateral side of the torque shaft 20 may reach the number 10 of the values 141 of the scale 14, which represents the largest torque thereof.

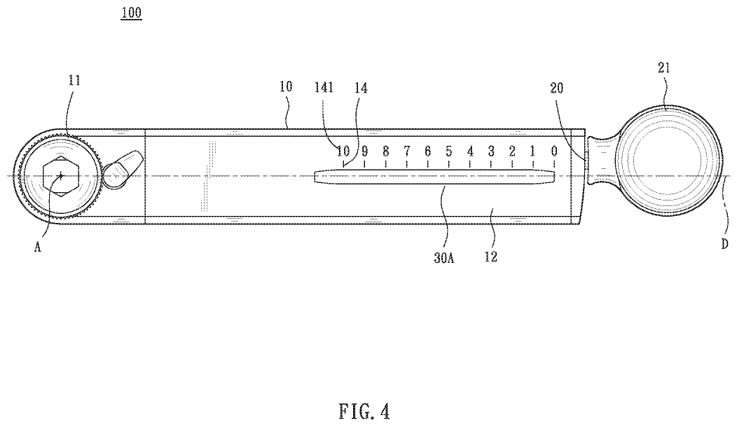

Of course, there are still many examples of the present invention, with only the details thereof are changed. As shown by FIG. 4, which is the second embodiment of the present invention, the main body 10 and torque wrench 20 are same as the first embodiment. The main difference compared with the first embodiment lies in that the torque indication portion is the window 30A arranged in a straight line on the main body 10 and overlapping the central line D.

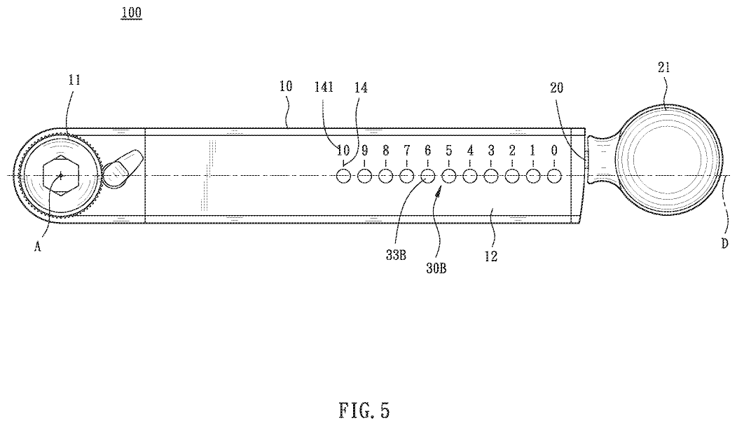

Referring to FIG. 5, the third embodiment also comprises the main body 10 and the torque shaft 20 same as the first embodiment. The main difference compared with the first embodiment lies in the torque indication portion, which is the window 30B formed on a plurality of bores 33B arranged in a straight line on the main body 10 and overlapping the central line. The bores 33B are allowed to have an identical bore diameter or have different bore diameters which are disposed according to the torque values and arranged orderly from larger to smaller (or from smaller to larger) torque values. Also, when the torque shaft 20 bends to enter the window 30B, the torque values are displayed by the bores 33B that are completely filled by the torque shaft 20.

The window 30A and 30B in the embodiment, besides of being arranged in a straight line and overlapping the central line D, are allowed to be arranged in a sloping line on the main body 10 and passing the central line D as the window 30. All of the window 30, window 30A, and window 30B identically achieves the torque values indication effects when the torque shaft 20 is bent.

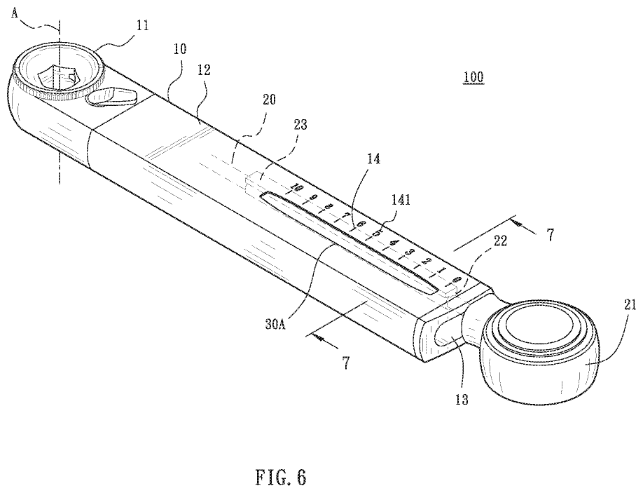

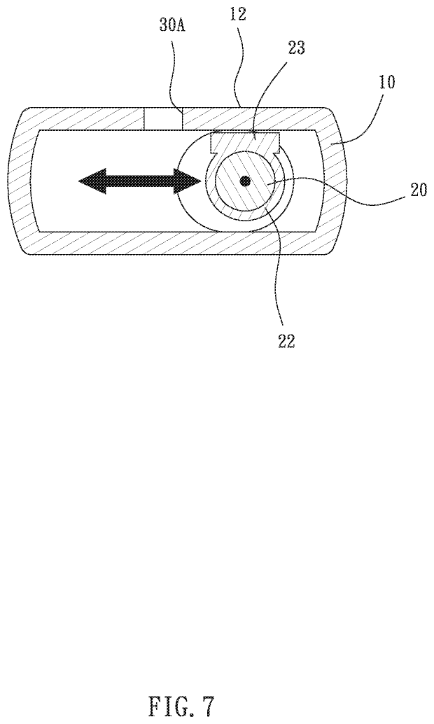

Referring to FIG. 6 and FIG. 7, the fourth embodiment is shown, which is based on the second embodiment and comprises the main body 10, the torque shaft 20, and the window 30A. The difference mainly lies in that the torque shaft 20 comprises an indicator 22, which is disposed on a segment of the torque shaft 22 which is displayable in the window 30A. The indicator 22 comprises an outer tube 23, and the indicator 22 is mounted around the torque shaft 20 through the outer tube 23. In the embodiment, the indicator 22 is formed in an elongate rectangular shape and disposed to face the window 30A. When the drive end 21 is wrenched toward the driving direction C, the outer tube 23 is bent together with the torque shaft 20, so that the indicator 22 enters the window 30A, and corresponding torque values are displayed by different lengths of the indicator 22 along the window 30A. The identical features in the embodiment is that when the torque shaft 20 is bent, the torque shaft 20 gradually fills the window 30A, wherein at least two torque values are filled by the torque shaft 20. Preferably, the indicator 22 in the embodiment comprises a colored surface layer 24. The colored surface layer 24, in the embodiment, has the indicator 22 which is dyed to present an obviously color difference with respect to the main body 10. When the indicator 22 displays the torque values along the window 30A, the colored surface layer 24 is clearly displayed on the window 30A.

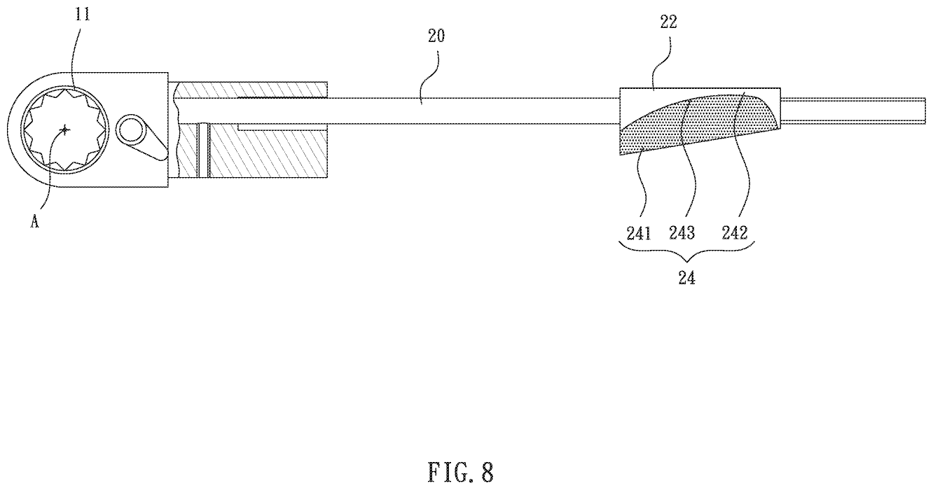

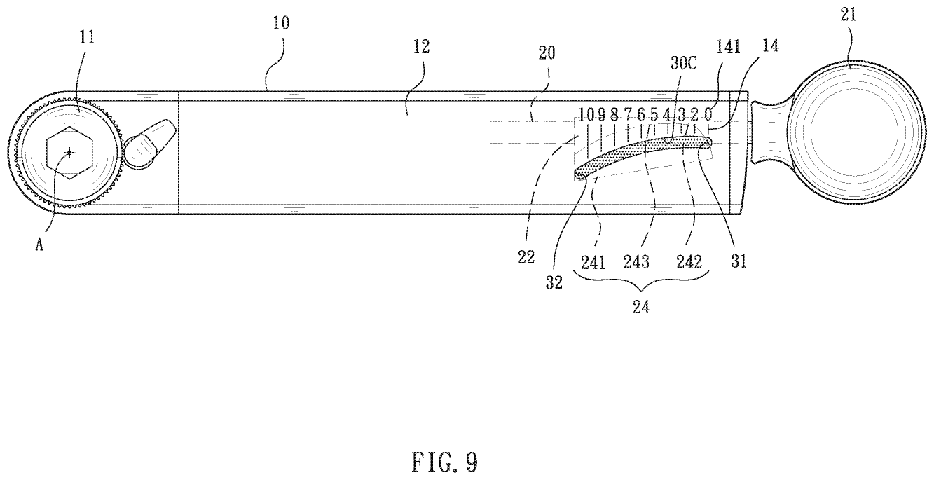

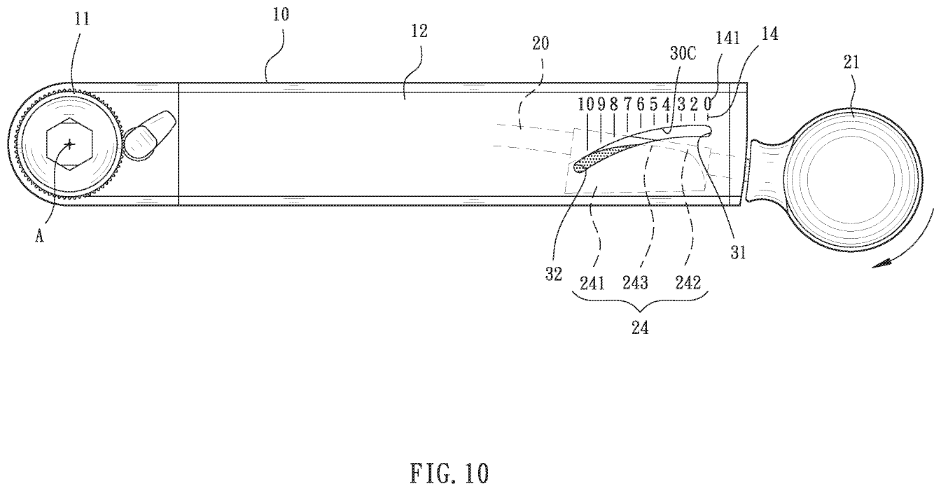

The fifth embodiment of the present invention comprises the main body 10, the torque shaft 20, and the window 30C, and the torque shaft 20 has the indicator 22. The indicator 22 is identically mounted around the torque shaft 20 through the outer tube 23. The indicator 22 also comprises a colored surface layer 24. The difference compared with the fourth embodiment mainly lies in that the window 30C is formed in an arc shape. The colored surface layer 24 comprises a first color zone 241 and a second color zone 242 having different colors, whereby a border line 243 is formed of the color difference between the first color zone 241 and the second color zone 242. The border line 243 extends between the first end 31 and the second end 32 along the window 30C, such that the border line 243 is formed in an arc shape along the window 30C (as shown by FIG. 8 and FIG. 9). The torque shaft 20 is bent from the axis B which is in parallel to the central line D toward the driving direction until the torque is generated, the border line 243 indicates the corresponding torque values in the window 30C (as shown by FIG. 10, number 10 of the value 141 of the scale 14 is indicated), so that the torque value is also clearly displayed in the window 30C. The identical features in the embodiment is that when the torque shaft 20 is bent, the torque shaft 20 gradually fills the window 30, wherein at least two values 141 (torque values) of the scale 14 are filled by the torque shaft 20. The torque values to be filled include values 141 from number 0 to 10 of the scale 14. Also in the embodiment, the colored surface layer 242 of the indicator 22 is dyed to present an obvious color difference with the main body 10. When the indicator 22 displays the torque value along the window 30C, the border line 243 is clearly displayed in the window 30C.

With the foregoing configuration, features of the present invention will be illustrated below. The torque indication portion (such as the window 30, window 30A, window 30B, and the window 30C) is disposed on the main body 10 together with the torque shaft 20 along the axis B. With the operation of the drive end 21, when the driven member is driven by the operation portion 11 to generate a torque, the torque shaft 20 is bent to different levels according to the increase of the torque, so that the torque shaft 20 displays the torque values with different length positions thereof along the torque indication portion. Also, upon being bent, the torque shaft 20 gradually fills the widow 30, such that at least two torque values are filled by the torque shaft 20 in the window 30. Compared to a conventional torque wrench which displays the torque value along the width direction, as for the same length and width sizes, the torque indication portion of the main body 10 of the present invention has a longer travel, and the display of the torque is enlarged, so that the torque shaft 20 clearly provides an easily visible torque values indication.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A torque wrench with torque value indication, comprising:
a main body comprising an operation portion on one end thereof and a display face, the operation portion driving a driven member to rotate about an axial center, two sides of the main body along a width direction thereof being sealed;
a torque shaft passing through the main body and disposed along an axis, the torque shaft having one end connected with the operation portion and another end provided with a drive end disposed located away from the operation portion and exposed from the main body, the drive end being imposed with a force toward a driving direction for wrenching the torque shaft, the torque shaft being bent toward the driving direction to deviate from the axis when a torque is generated; and
a torque indication portion formed in an elongate shape and disposed on the display face of the main body along a direction of the axis, the torque indication portion comprising a first end and a second end, the torque shaft gradually bending from the first end toward the second end in accordance with an increase of the torque, so as to display a corresponding torque value with different length positions of the torque shaft along the torque indication portion.

2. The torque wrench of claim 1, wherein the torque indication is a window, which is formed in a single opening or a plurality of bores arranged in an elongate shape; the torque shaft gradually fills the window during bending, and at least two torque values in the window are filled by the torque shaft.

3. The torque wrench of claim 2, wherein the main body is formed in a cuboid and comprises a length, a width, and a thickness, and a central line extending along a length direction; the driving direction is defined as a clockwise direction of the main body rotating about the axial center; the axis extends toward the length direction of the main body; the central line passes through the axial center; the axis of the torque shaft is in parallel to the central line; the window is disposed along a direction of the central line.

4. The torque wrench of claim 3, wherein the window is formed in an arc shape on the main body.

5. The torque wrench of claim 3, wherein the window is arranged in a straight line on the main body and overlaps the central line.

6. The torque wrench of claim 3, wherein the window is arranged in a sloping line on the main body.

7. The torque wrench of claim 3, wherein the torque shaft comprises an indicator disposed on a segment thereof displayable in the window and facing the window, such that the corresponding torque value is displayed by the indicator on different length positions of the torque shaft along the window.

8. The torque wrench of claim 7, wherein the indicator comprises an outer tube, and the indicator is mounted around the torque shaft through the outer tube and located on a segment of the torque shaft displayable in the window.

9. The torque wrench of claim 7, wherein the indicator comprises a colored surface layer; when the indicator indicates the torque value along the window, the colored surface layer is clearly displayed in the window.

10. The torque wrench of claim 9, wherein the indicator comprises an outer tube, and the indicator is mounted around the torque shaft through the outer tube and located on a segment of the torque shaft displayable in the window.

11. The torque wrench of claim 9, wherein the colored surface layer comprises a first color zone and a second color zone having different colors, with a border line being formed of a color difference between the first color zone and the second color zone; the border line extends between the first end and the second end along with the window; when the torque shaft is bent from the axis which is in parallel to the central line toward the driving direction to generate the torque, the border line indicates the corresponding torque values in the window.

12. The torque wrench of claim 11, wherein the indicator comprises an outer tube, and the indicator is mounted around the torque shaft through the outer tube and located on a segment of the torque shaft displayable in the window.

13. The torque wrench of claim 2, wherein the main body comprises a plurality of scales; each scale is provided with a value for displaying the corresponding torque values; the values increases from the first end toward the second end.

14. The torque wrench of claim 13, wherein the first end is closer, compared to the second end, to the drive end and the axis, and the second end is relatively away from the drive end and the axis.

15. The torque wrench of claim 13, wherein the second end is closer, compared to the first end, to the drive end and the axis, and the first end is relatively away from the drive end and the axis.
